(19) United States
(12) Patent Application Publication
(10) Pub. No.: US 2016/0272229 A1
(43) Pub. Date: Sep. 22, 2016

(54) HITCH MOUNTED CARRIERS AND RELATED METHODS

(71) Applicant: Joshua Andrew Buckner, Jackson, GA (US)

(72) Inventor: Joshua Andrew Buckner, Jackson, GA (US)

(21) Appl. No.: 15/074,318

(22) Filed: Mar. 18, 2016

Related U.S. Application Data
(60) Provisional application No. 62/135,376, filed on Mar. 19, 2015.

(51) Int. Cl. B62B 3/02; B62B 5/06; B60D 1/54

(52) U.S. Cl. CPC B62B 3/02; B60D 1/54; B62B 5/067

(57) ABSTRACT

Systems and methods for hitch mounted cargo carriers are disclosed herein. The cargo carriers can comprise a storage assembly, leg assemblies, a hitch assembly, and a handle assembly. Advantageously, the cargo carriers can easily mate with the hitch of a car or truck, be transported via the car or truck, and then be detached and wheeled to a desired location, such as a hotel room or tailgating spot. The leg assemblies and hitch assembly of the cargo carriers can be foldable for easy transport and storage.

### CROSS-REFERENCE TO RELATED APPLICATIONS

This application claims the benefit of U.S. Provisional Patent Application No. 62/135,376 filed 19 Mar. 2015, the entire contents and substance of which is hereby incorporated by reference.

### BACKGROUND

1. Field of the Invention

The present invention relates to hitch mounted carriers and related methods, and more specifically, to hitch mounted carriers that can easily be inserted and attached to a vehicle hitch, adjusted to each vehicle height and depth, then, without lifting or carrying, easily detached and removed from the vehicle, made mobile with folding leg assemblies, and transported to and from various locations by the attached leg and wheel assemblies.

2. Description of Related Art

Several hitch mounted cargo carriers are known. As those of skill in the art will understand, these hitch mounted cargo carriers facilitate the transport of luggage or other belongings. Hitch mounted cargo carriers advantageously attach to a hitch of a car or truck, thereby not taking up space in the car or truck and leaving more room for people and other items in the vehicle. Known hitch mounted cargo carriers, however, have reoccurring problems for numerous traveling audiences: families traveling together on vacation, tournament and traveling athletic teams, traveling tradeshow vendors, fans tailgating, and anyone else who may be traveling and transporting luggage or other belongings from point A to point B.

For years, travelers have needed the added storage space provided by hitch mounted cargo carriers; however the ease of loading, unloading, and transporting was lacking. Once a traveler arrived at a destination, the tired traveler had to go on the exhausting hunt for a luggage cart provided by the hotel, condo, or vendor. After waiting and searching, the tired and now irritable traveler had to proceed with unpacking his or her luggage onto the luggage cart provided. One problem now is that the much needed cargo carrier is empty and attached to the car, but no longer needed for daily driving. The traveler must either ask a fellow traveler to help detach it and lug it to a storage area (such as the traveler's hotel room, where it will take up space) or leave it attached to the automobile hitch for the remainder of the stay. If the carrier is stored in the room, then its large size and bulky shape only create more chaos and stress for the stay. If, on the other hand, the carrier remains on the automobile, it creates an increased potential for accidents and insurance claims. Not to mention the cargo carrier makes the traveler's automobile look unattractive and lets others know that the traveler is from out of town.

Accordingly, there is a need for improved cargo carriers and related methods that address the concerns above, and embodiments of the present disclosure are directed to these and other considerations.

### SUMMARY

Briefly described, embodiments of the present disclosure relate to an improved hitch mounted cargo carrier. The cargo carrier can solve the traveler's problems discussed above, thereby providing an enhanced travel experience. In some embodiments, the cargo carrier can be identified as the “Ruk Freedom Hiker.”

In some embodiments, the cargo carrier can have adjustable height leg assemblies, each having one or more wheels. A traveler can easily set the adjustable height legs to the exact height of the vehicle to which it is to be attached. In this manner, the legs and wheels allow the user to effortlessly align and insert the tongue of the carrier's hitch assembly into the vehicle's receiver (or hitch). After attachment, the cargo carrier's ergonomically designed pull pin release system allows the user to easily fold and lock the legs and wheels up into the footprint of the cargo carrier, eliminating the possibility for the legs and/or wheels to contact the road surface while traveling.

Once the traveler arrives at their destination, the traveler can simply use the pull pin release system to lower the legs, which were previously set to that vehicle's hitch height. A cleverly stored handle can then be deployed to an active position from the end of the cargo carrier for pushing or pulling to the desired location. The cargo carrier's hitch assembly is configured to allow the adjustable hitch tongue to be switched from an extended position to a retracted position within the footprint of the cargo area so that the carrier fits through doors and hallways, and can be maneuvered in small spaces, such as elevators, without knocking into the user, a bystander, or other object and causing injury or damage. One or more of the cargo carrier's wheels can be castors rotatable in 360 degrees, and one or more of these castors can be equipped with a locking pin that allows the castor to become fixed for straight-line tracking and direction, again improving ease of maneuverability in certain situations.

Embodiments of the present invention have been carefully designed with the user and the user's safety in mind. For example, the cargo carrier eliminates potential safety hazards, such as needing to crawl under the vehicle to attach the cargo carrier, or needing to lift the carrier to attach it to the vehicle.

In one embodiment, a cargo carrier is provided comprising a storage assembly; a first leg assembly comprising a first wheel and a second wheel, the first leg assembly attached to an underside of the storage assembly proximate a first end of the storage assembly; a second leg assembly comprising a first wheel and a second wheel, the second leg assembly attached to the underside of the storage assembly proximate a second end of the storage assembly; a hitch assembly attached to the underside of the storage assembly along a center line of the storage assembly; and a handle assembly attached proximate a first end of the storage assembly.

In some embodiments, the storage assembly comprises a top frame, a bottom frame, and a carrier base, wherein the top frame may be affixed to a top edge of the carrier base and the bottom frame may be affixed to a base of the carrier base. In such embodiments, the storage assembly defines an area where cargo may be stowed.

In some embodiments, the first leg assembly and the second leg assembly each comprise a pair of adjustable legs affixed to a pivot assembly with each adjustable leg having a caster affixed to a lower end. The first leg assembly and the second leg assembly may each be pivotable from a retracted position to a deployed position. The first leg assembly and the second leg assembly may be configured to be pivoted to the retracted position when the cargo carrier is affixed to a vehicle hitch, and the leg assembly and the second leg assembly may be configured to be pivoted to the deployed position for independently moving the cargo carrier from a first location to a second location. In some embodiments, two or more of the casters affixed to the adjustable legs may be adjusted from a fixed straight-line operation to a 360-degree rotation operation. In some embodiments, each adjustable leg may be configured to be adjusted between a height of 11 inches and 22 inches independently.

In some embodiments, the hitch assembly comprises a hitch housing affixed to the underside of the storage assembly; an adjustable hitch tongue which can be received within the hitch housing; and a hitch pin for securing the adjustable hitch tongue within the hitch housing. The adjustable hitch tongue may be configured to be transitioned from a retracted position to an extended position within the hitch housing to provide for mounting the cargo carrier to a vehicle hitch.

In some embodiments, the adjustable hitch tongue may further comprise a hitch mounting hole and an adjustable hitch stop. The adjustable hitch stop may be set to allow for alignment between the hitch mounting hole of the adjustable hitch tongue and a mounting hole on a vehicle hitch receiver. In some embodiments, the hitch housing may further comprise a slot for receiving the adjustable hitch stop when the adjustable hitch tongue is placed in a retracted position.

In some embodiments, the handle assembly comprises a pivot bracket affixed proximate the first end of the storage assembly; a handle sleeve affixed within the pivot bracket such that the handle sleeve can pivot about a pivot point from a active position to a storage position; a handle affixed within the handle sleeve and that can pivot along with the handle sleeve from the active position to the storage position; a handle guide affixed to the underside of the storage assembly for receiving the handle when in the storage position; and a pin to secure the handle sleeve and the handle in either of the active position or the storage position.

Further features of the disclosed design, and the advantages offered thereby, are explained in greater detail hereinafter with reference to specific embodiments illustrated in the accompanying drawings, wherein like elements are indicated by like reference designators.

### BRIEF DESCRIPTION OF THE DRAWINGS

FIG. 1 depicts a view of a cargo carrier, in accordance with some embodiments of the present invention.

FIG. 2 depicts a first end view of a cargo carrier, in accordance with some embodiments of the present invention.

FIG. 3 depicts a second end view of a cargo carrier, in accordance with some embodiments of the present invention.

FIG. 4 depicts a top view of a cargo carrier storage assembly, in accordance with some embodiments of the present invention.

FIG. 5A depicts a top view of partial leg assemblies of a cargo carrier, in accordance with some embodiments of the present invention.

FIG. 5B depicts a side view of partial leg assemblies of a cargo carrier, in accordance with some embodiments of the present invention.

FIG. 6A depicts an adjustable caster leg of a leg assembly of a cargo carrier, in accordance with some embodiments of the present invention.

FIG. 6B depicts a pivot leg carrier of a leg assembly of a cargo carrier, in accordance with some embodiments of the present invention.

FIG. 6C depicts a pivot leg carrier pin of a leg assembly of a cargo carrier, in accordance with some embodiments of the present invention.

FIG. 7A depicts a view of a handle assembly of a cargo carrier, in accordance with some embodiments of the present invention.

FIG. 7B depicts views of some components of a handle assembly of a cargo carrier, in accordance with some embodiments of the present invention.

FIG. 8A depicts a top view of a hitch housing of a hitch assembly of a cargo carrier, in accordance with some embodiments of the present invention.

FIG. 8B depicts a bottom view of a hitch housing of a hitch assembly of a cargo carrier, in accordance with some embodiments of the present invention.

FIG. 8C depicts an end view of a hitch housing of a hitch assembly of a cargo carrier, in accordance with some embodiments of the present invention.

FIG. 9A depicts a top view of an adjustable hitch of a hitch assembly of a cargo carrier, in accordance with some embodiments of the present invention.

FIG. 9B depicts a side view of an adjustable hitch of a hitch assembly of a cargo carrier, in accordance with some embodiments of the present invention.

FIG. 10A depicts a top view of a hitch assembly of a cargo carrier in a retracted position, in accordance with some embodiments of the present invention.

FIG. 10B depicts a side view of a hitch assembly of a cargo carrier in a retracted position, in accordance with some embodiments of the present invention.

FIG. 10C depicts a bottom view of a hitch assembly of a cargo carrier in a retracted position, in accordance with some embodiments of the present invention.

FIG. 10D depicts top view of a hitch assembly of a cargo carrier in an extended position, in accordance with some embodiments of the present invention.

FIG. 10E depicts a side view of a hitch assembly of a cargo carrier in an extended position, in accordance with some embodiments of the present invention.

FIG. 10F depicts a bottom view of a hitch assembly of a cargo carrier in an extended position, in accordance with some embodiments of the present invention.

FIG. 11 depicts a view of an unmounted or deployed cargo carrier, in accordance with some embodiments of the present invention.

FIG. 12 depicts a view of a mounted cargo carrier, in accordance with some embodiments of the present invention.

FIG. 13 depicts a view of a deployed leg assembly of a cargo carrier, in accordance with some embodiments of the present invention.

FIG. 14 depicts a view of a retracted leg assembly of a cargo carrier, in accordance with some embodiments of the present invention.

FIG. 15 depicts a view of a deployed handle assembly of a cargo carrier, in accordance with some embodiments of the present invention.

FIG. 16 depicts a close-up view of a deployed handle assembly of a cargo carrier, in accordance with some embodiments of the present invention.

FIG. 17 depicts a view of a hitch assembly of a cargo carrier, in accordance with some embodiments of the present invention.

FIG. 18 depicts a view of a hitch housing, in accordance with some embodiments of the present invention.

FIG. 19 depicts a view of an adjustable hitch tongue of a cargo carrier, in accordance with some embodiments of the present invention.

FIG. 20 depicts a view of an adjustable hitch tongue of a cargo carrier, in accordance with some embodiments of the present invention.

### DETAILED DESCRIPTION

To facilitate an understanding of the principles and features of the various embodiments of the invention, various illustrative embodiments are explained below. Although exemplary embodiments of the invention are explained in detail as being hitch mounted cargo carriers and related methods, it is to be understood that other embodiments are contemplated, such as embodiments employing other types of cargo carriers. Accordingly, it is not intended that the invention is limited in its scope to the details of construction and arrangement of components set forth in the following description or examples. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

To facilitate an understanding of the principles and features of this disclosure, various illustrative embodiments are explained below. In particular, various embodiments of this disclosure are described as hitch mounted cargo carriers and related methods. Some embodiments of the invention, however, may be applicable to other contexts, such as carriers mountable to other support systems, and embodiments employing these applications are contemplated.

As described above, problems with conventional hitch mounted cargo carriers include the need to remove the luggage or belongings from the carrier once a traveler has arrived at his or her destination, then remove the carrier from the vehicle without the aid of wheels, then store the carrier, then later reattach the carrier when he or she leaves the destination (once again without the aid of wheels), and then return the luggage or belongings to the carrier. This process is exhausting and stress inducing. And if the carrier is not removed, it is an eyesore and can increase the likelihood that the traveler gets into a vehicle accident.

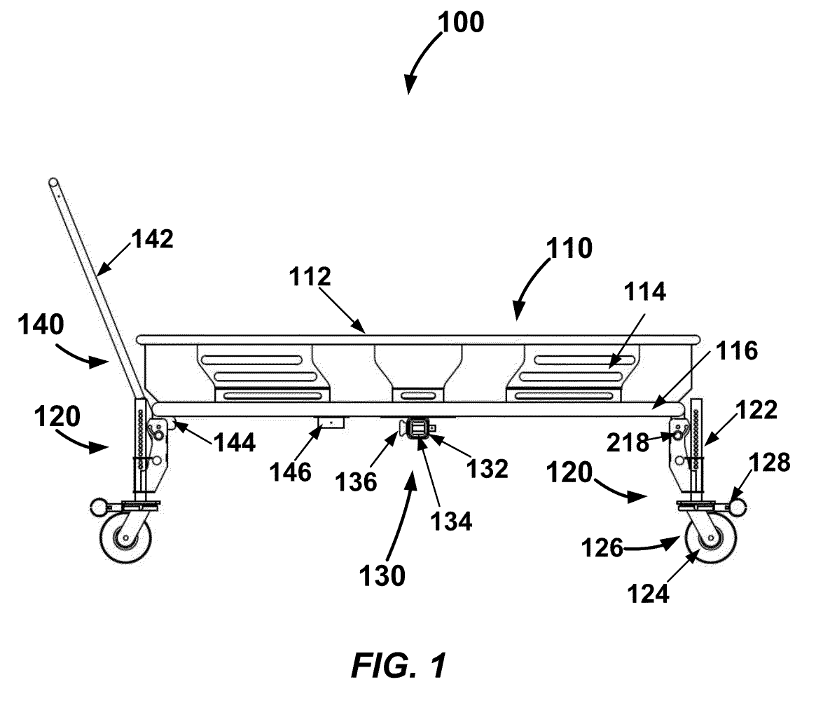

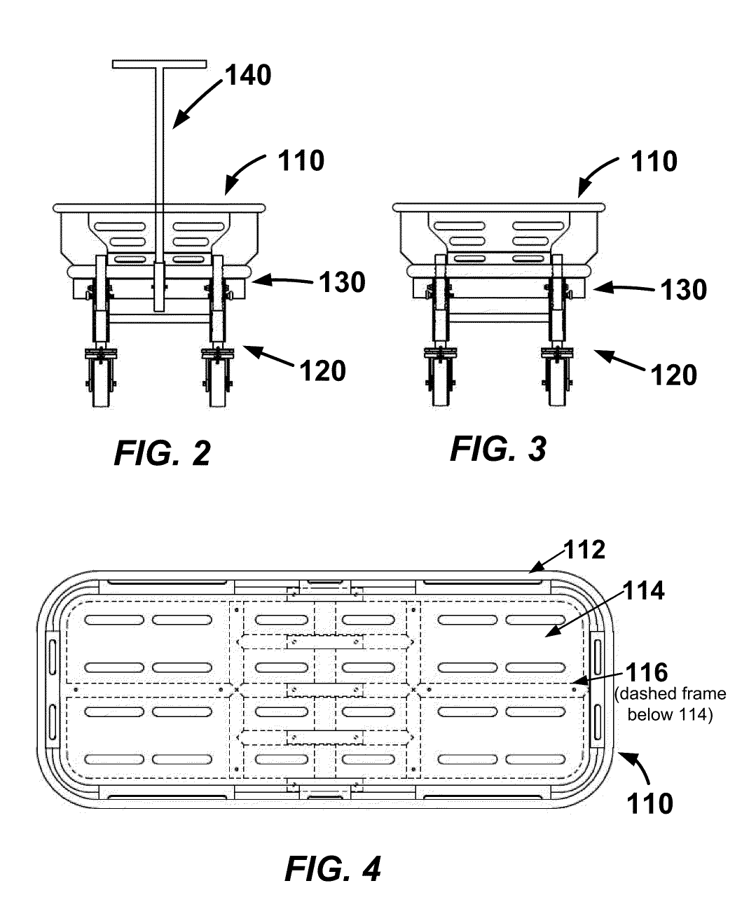

To alleviate these and other problems, FIGS. 1, 2, and 3 depict a cargo carrier 100 in accordance with some embodiments of the present invention. FIG. 1 depicts a side view of an embodiment of a cargo carrier 100 in an unmounted or deployed configuration. FIG. 2 depicts a front end view of an embodiment of a cargo carrier 100 in a deployed configuration. FIG. 3 depicts a rear end view of an embodiment of a cargo carrier 100 in a deployed configuration.

As can be seen in FIG. 1, the cargo carrier 100 can comprise a storage assembly 110, multiple leg assemblies 120, a hitch assembly 130, and a handle assembly 140. In some embodiments, the storage assembly 110 may comprise a top frame 112, a carrier base 114, and a bottom frame 116. In some embodiments, the leg assemblies 120 may comprise adjustable pivot leg assemblies 122 and castors 126, which may further comprise wheels 124 and lock mechanisms 128. In some embodiments, the hitch assembly 130 may comprise a hitch housing 132, adjustable hitch tongue 134, and hitch pin 136. In some embodiments, the handle assembly 140 may comprise a T-handle 142, a pivot bracket 144, and a handle guide 146.

As shown in FIG. 1 and FIG. 4, in some embodiments, the storage assembly 110 may comprise a top frame 112, a carrier base 114, and a bottom frame 116. The carrier base 114 can be substantially flat and can provide an ideal resting location for a traveler's belongings or other cargo. In some embodiments, the carrier base 114 comprises the bottom of the storage assembly 110. The top frame 112 and bottom frame 116 can surround the carrier base 114 and can help contain the traveler's belongings or cargo within the cargo carrier 100. The top frame 112 and bottom frame 116 can be designed in a variety of configurations and can provide lateral support to the traveler's belongings or cargo when the cargo carrier 100 is in motion, such as when it accelerates or decelerates. Other containing or securing devices, such as straps or nets, can also be secured to the carrier base 114, top frame 112, or bottom frame 116 to help maintain the traveler's belongings or cargo in the cargo carrier 100.

As shown in FIGS. 1, 2, and 3, in some embodiments, the cargo carrier 100 can comprise one or more leg assemblies 120. In some embodiments, for example, the cargo carrier can comprise two leg assemblies 120, or four leg assemblies 120. Each leg assembly 120 can comprise a variety of components. Advantageously, each leg assembly can comprise one or more wheels 124 that can be part of one or more castors 126. In some embodiments, as shown, each leg assembly can comprise two castors 126, each castor 126 having one wheel 124. In some embodiments, each castor 126 can rotate through 360 degrees to enable the cargo carrier 100 to be easily maneuverable. In some embodiments, one or more of the castors 126 or wheels 124 are equipped with a locking pin or mechanism 128 that allows the castors or wheels to lock in a fixed direction (keep from rotating) for straight-line tracking and direction control. In some embodiments, the castors or wheels of a single leg assembly, for example the rear leg assembly, may be equipped with the locking mechanism to lock in a fixed direction while the castors or wheels of the other leg assembly, for example the front leg assembly, continue to be rotatable through 360 degrees to allow for ease of direction control during movement of the carrier.

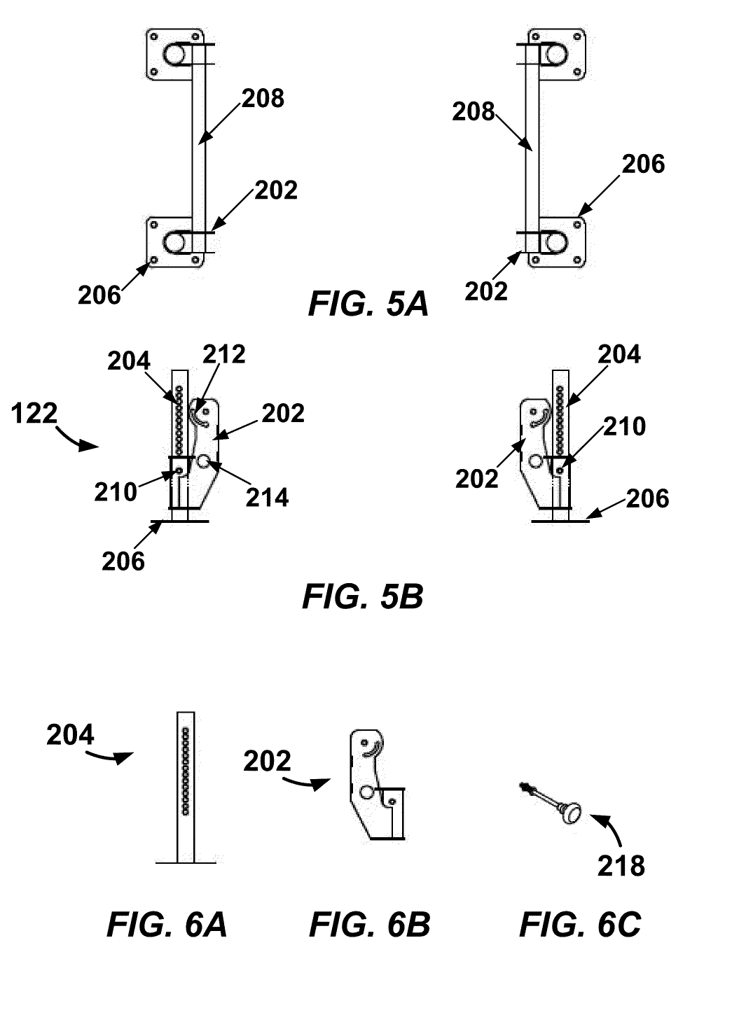

Further details of the leg assemblies 120 are depicted in FIGS. 5A-B and 6A-C in accordance with some embodiments of the present invention. For example, in some embodiments, leg assemblies 120 may further comprise adjustable pivot leg assemblies 122 which may further comprise adjustable legs 204, pivot assemblies 202, and castor plates 206, as depicted in FIG. 5B. In some embodiments, leg assemblies 120 may further comprise cross members 208 joining two adjustable pivot leg assemblies 122 in a leg assembly 120, as depicted in FIG. 5A. In some embodiments, cross members 208 may be secured through cross member guides 214 within the pivot assemblies 202, as depicted in FIGS. 5A and 5B. FIG. 6A depicts an adjustable leg 204 of an adjustable pivot leg assembly 122 in accordance with some embodiments of the present invention. FIG. 6B depicts a pivot assembly 202 of an adjustable pivot leg assembly 122 in accordance with some embodiments of the present invention. FIG. 6C depicts a pull pin 218 of an adjustable pivot leg assembly 122 in accordance with some embodiments of the present invention. The pull pin 218 may be affixed to the leg assembly and the cargo carrier through a pull pin guide 212 of a pivot assembly 202 and the pull pin 218 may be moved through the pull pin guide 212 to extend or retract the leg assembly and lock the leg assembly in an extended or retracted position.

In some embodiments, the leg assemblies 120 can be vertically adjustable, to vary the height of the cargo carrier 100, for example, to allow for ease of mounting the carrier to a vehicle. In some embodiments, each leg of the leg assemblies 120 can be individually adjusted to allow for a variety of surface elevations or conditions. In some embodiments, for example, the leg assemblies can be adjustable to enable the adjustable hitch tongue 134 of the hitch assembly 130 to be between 11 inches and 22 inches from the ground. This can enable the cargo carrier 100 to easily join with several different vehicles, each having hitches of varying heights. In this regard, a traveler can easily set the cargo carrier's 100 adjustable leg assemblies 120 to the exact height of the vehicle's hitch. In some embodiments, the leg assemblies 120 can be vertically adjusted by releasing a leg carrier pin 210 in a pivot assembly 202 allowing for an adjustable leg 204 to be moved up or down to vary the height of a leg assembly and the adjustable leg 204 can then be locked at the adjusted height using the leg carrier pin 210.

In some embodiments, the leg assemblies 120 can fold to a retracted position to enable the cargo carrier 100 to be supported by the vehicle at the outset of a trip, and to enable the cargo carrier to regain support from the ground at the end of a trip. In this regard, the leg assemblies 120 of the cargo carrier 100 can comprise a pull pin release system. As shown in FIGS. 1, 5, and 6, in some embodiments, the pull pin release system can comprise one or more spring activated pull pins 218 (example shown in FIG. 6C) that can be manipulated through a pull pin guide 212 of a pivot assembly 202 to enable the leg assemblies 120 to fold upward and lock into a storage position via the pull pin 218. In this manner, the leg assemblies 120 can be stored during travel, to prevent the wheels 124 or any other portion of the leg assemblies 120 from contacting the ground during vehicle movement. The pull pins 218 can later be manipulated to enable the leg assemblies 120 to fold downward and lock into a support position, at which time the leg assemblies 120 can support the cargo carrier 100. In some embodiments, the pull pin release system can be ergonomically designed.

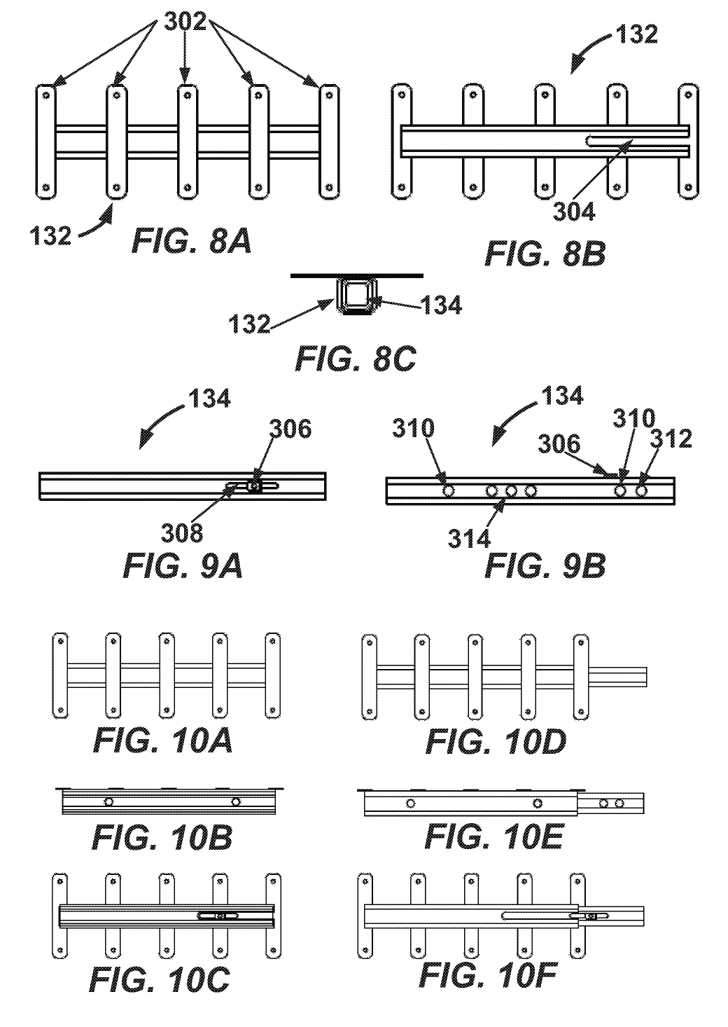

FIG. 8A through FIG. 10F depict various aspects of a hitch assembly 130 of a cargo carrier 100 in accordance with some embodiments of the present invention. As shown in FIG. 1 and FIG. 8A through FIG. 10F, the hitch assembly 130 can comprise a hitch housing 132, adjustable hitch tongue 134, and hitch pin 136. In use, the hitch assembly 130 can support the cargo carrier 100 when the cargo carrier 100 is attached or mounted to a vehicle (via a vehicle hitch receiver for example). FIG. 8A depicts a top view of a hitch housing 132, FIG. 8B depicts a bottom view of a hitch housing 132, and FIG. 8C depicts an end view of a hitch housing 132 in accordance with some embodiments. In some embodiments, the hitch housing 132 comprises mounting tabs 302 which provide for the hitch housing 132 to be secured to the storage assembly 110 of the cargo carrier 100. The hitch housing 132 of hitch assembly 130 allows for an adjustable hitch tongue 134 to be secured within the hitch housing 132, as illustrated in FIGS. 8C and 10A-F, via a hitch pin 136. In some embodiments, the hitch housing 132 may comprise a hitch stop slot 304 which provides for a hitch stop assembly 306 of the adjustable hitch tongue 134 to be positioned within the hitch housing 132 when the adjustable hitch tongue 134 is in a retracted position (as shown in FIG. 10C).

The hitch housing 132 provides for the adjustable hitch tongue 134 to be moved from an extended position, whereby it desirably engages with the hitch or receiver on the back of a vehicle, to a retracted position, whereby it is stowed while the cargo carrier 100 is not secured to a vehicle. In the retracted position, the adjustable hitch tongue 134 is contained within the footprint of the storage assembly 110 of the cargo carrier 100 to facilitate movement of the cargo carrier 100 and reduce the chance that the adjustable hitch tongue 134 will contact an object such as a wall or person, potentially causing harm.

FIG. 9A depicts a top view of the adjustable hitch tongue 134 and FIG. 9B depicts a side view of the adjustable hitch tongue 134 in accordance with some embodiments. As shown in FIG. 9A, in some embodiments, the adjustable hitch tongue 134 may comprise an adjustable hitch stop assembly 306 which can be preset to allow for ease of securing the cargo carrier 100 to a vehicle. For example, the hitch stop assembly 306 may be moved within slot 308 of the adjustable hitch tongue 134 based on the position of a mounting hole in a vehicle hitch or receiver. In such fashion, when the adjustable hitch tongue 134 is inserted into the vehicle hitch or receiver to the point of the hitch stop assembly 306 (as shown in FIG. 20), a hitch mounting hole 312 of adjustable hitch tongue 134 may properly align with a mounting hole of the vehicle hitch or receiver to allow for easily inserting a vehicle's hitch pin to secure the cargo carrier to the vehicle hitch or receiver.

As shown in FIG. 9B, in some embodiments, the adjustable hitch tongue 134 may comprise retracted locking holes 310 and carrier mounting holes 314 to allow for securing the adjustable hitch tongue 134 in a retracted position or an extended position within the hitch housing 132 via hitch pin 136. The adjustable hitch tongue 134 may further comprise one or more hitch mounting holes 312 to allow for securing the adjustable hitch tongue 134 in a vehicle's hitch or receiver (via a vehicle's hitch pin). For example, when the adjustable hitch tongue 134 is in a retracted position, as depicted in FIG. 10B, a retracted locking hole 310 may align with a hole in the hitch housing 132 to provide for securing the adjustable hitch tongue 134 within the hitch housing 132 using hitch pin 136 (for example, when the cargo carrier is not mounted to a vehicle). When the adjustable hitch tongue 134 is in an extended position, as depicted in FIG. 10E, a carrier mounting hole 314 may align with a hole in the hitch housing 132 to provide for securing the adjustable hitch tongue 134 in the extended position within the hitch housing 132 using hitch pin 136 and provide for the hitch mounting hole 312 to be exposed to allow the adjustable hitch tongue 134 to be inserted and secured into a vehicle hitch or receiver (by aligning the hitch mounting hole 312 with a hole in the vehicle's hitch or receiver and securing with the vehicle's hitch pin).

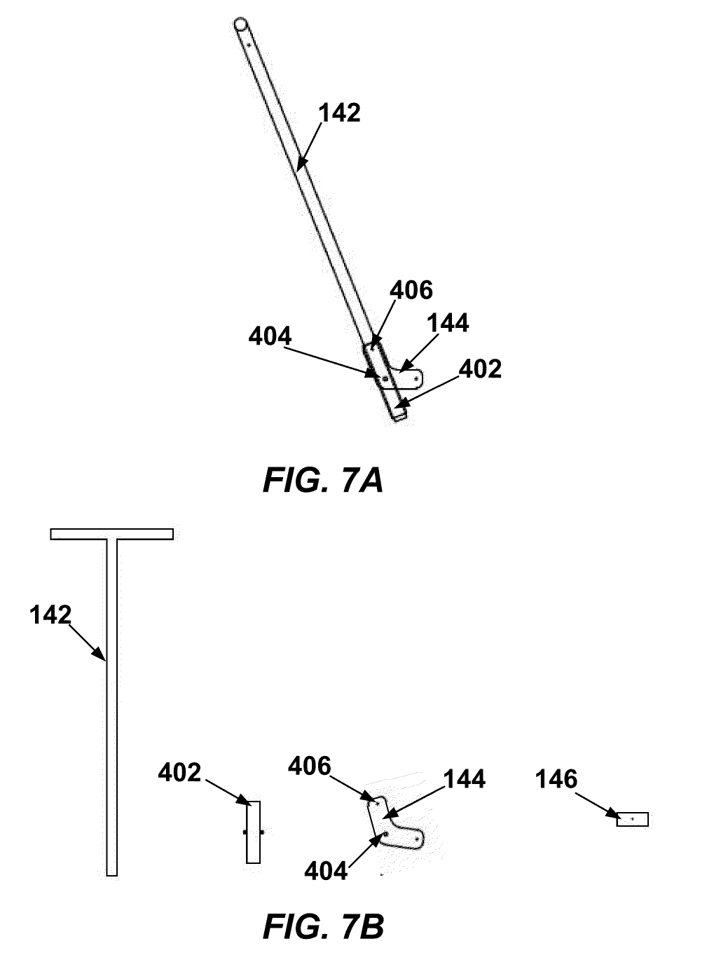

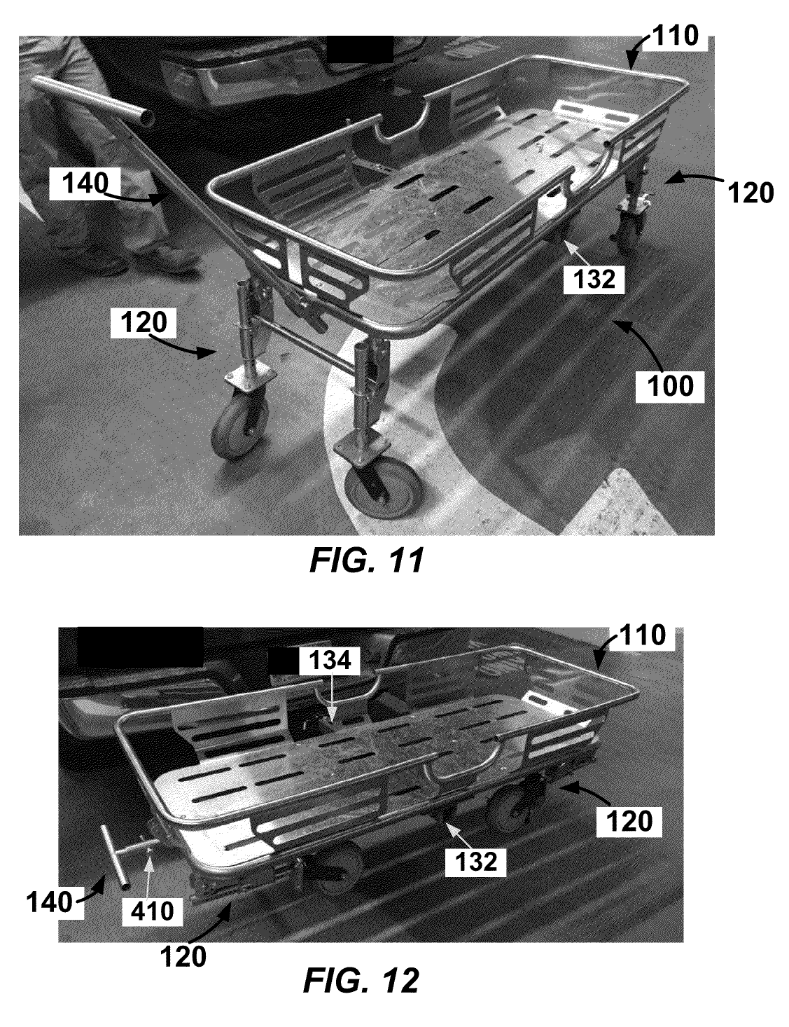

In some embodiments, the cargo carrier 100 can further comprise a handle assembly 140. The handle assembly 140 can be placed in a storage configuration during travel, as shown in FIG. 12, and can be moved to an active configuration to enable easy pulling or pushing of the cargo carrier 100, as shown in FIG. 1 and FIG. 11. In some embodiments, the handle assembly 140 may comprise a T-handle 142, a pivot bracket 144, and a handle guide 146, as shown in FIG. 1, FIG. 7A, and FIG. 7B. The T-handle 142 may be secured in the pivot bracket 144 via a handle sleeve 402. To place the handle assembly 140 in the active configuration, as shown in FIG. 1, the T-handle 142 may be extended and pivoted, along with the handle sleeve 402, to an active position about pivot point 404 in pivot bracket 144, as shown in FIG. 7A. Once placed in the active configuration, the T-handle 142 and handle sleeve 402 may be locked in the active configuration via a pin 410 secured through an active position locking hole 406 in the pivot bracket 144, as shown in FIG. 16. To place the handle assembly 140 in the storage configuration, the pin 410 may be removed from the active position locking hole 406 allowing the T-handle 142, along with the handle sleeve 402, to be pivoted about pivot point 404 in pivot bracket 144 and inserting the T-handle 142 into a handle guide 146 mounted to the underside of the storage assembly 130 (shown in FIG. 1). Once placed in the storage configuration, the T-handle 142 and handle sleeve 402 may be locked in the storage configuration via a pin 410 secured through a storage position locking hole in the handle sleeve 402 or in the pivot bracket 144.

FIGS. 11-20 depict various other views of the cargo carrier 100 in accordance with an embodiment of the present invention. FIG. 11 depicts a view of an unmounted or deployed cargo carrier 100 in accordance with an embodiment of the present invention. As shown in FIG. 11, the leg assemblies 120 are placed in a deployed or extended configuration, providing support for the cargo carrier 100 and allowing the cargo carrier 100 to be independently moved about as desired. FIG. 11 also shows the handle assembly 140 in an active configuration allowing for pushing or pulling of the cargo carrier. FIG. 12 depicts a view of a mounted cargo carrier in accordance with an embodiment of the present invention. As shown in FIG. 12, the leg assemblies 120 are placed in a retracted configuration, allowing for the cargo carrier 100 to be supported by the vehicle hitch and keeping the leg assemblies from contacting the ground. FIG. 12 also shows the handle assembly 140 in a storage configuration, with the T-handle 142 inserted under the storage assembly 110 and into a handle guide 146 (not shown). FIG. 12 also shows the T-handle being secured in the storage position using pin 410.

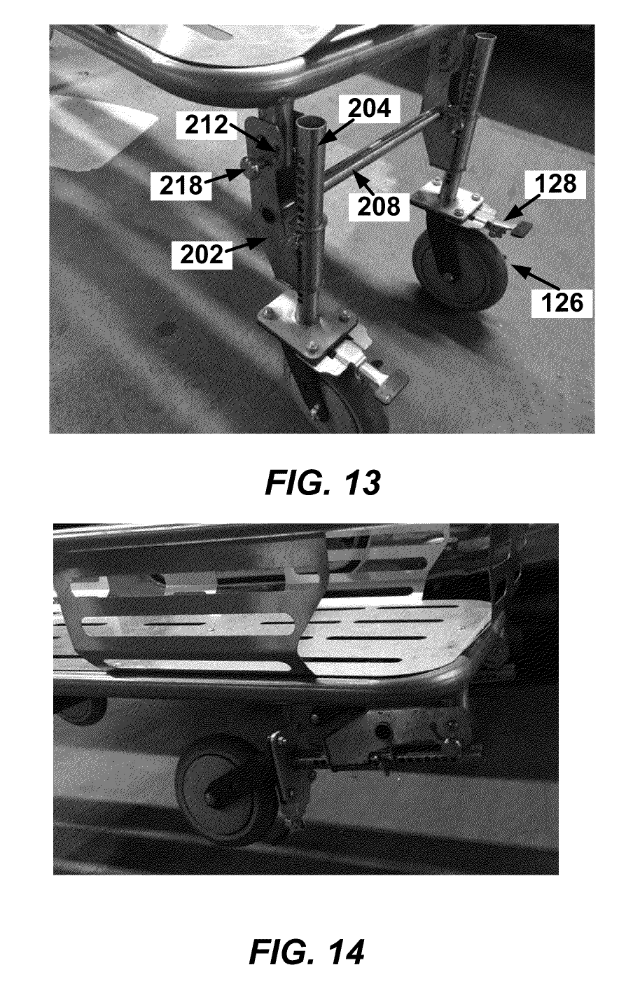

FIG. 13 depicts a view of an extended or deployed leg assembly 120 of a cargo carrier 100 with the leg assembly 120 being locked in the extended position using pull pins 218, in accordance with an embodiment of the present invention. As shown in FIG. 13, the locking mechanism 128 of the castors 126 is in a locked position allowing the castors 126/wheels 124 to be tracked in a straight line allowing for ease of controlling movement and direction of the cargo carrier 100. FIG. 14 depicts a view of a retracted leg assembly 120 of a cargo carrier 100 in accordance with an embodiment of the present invention.

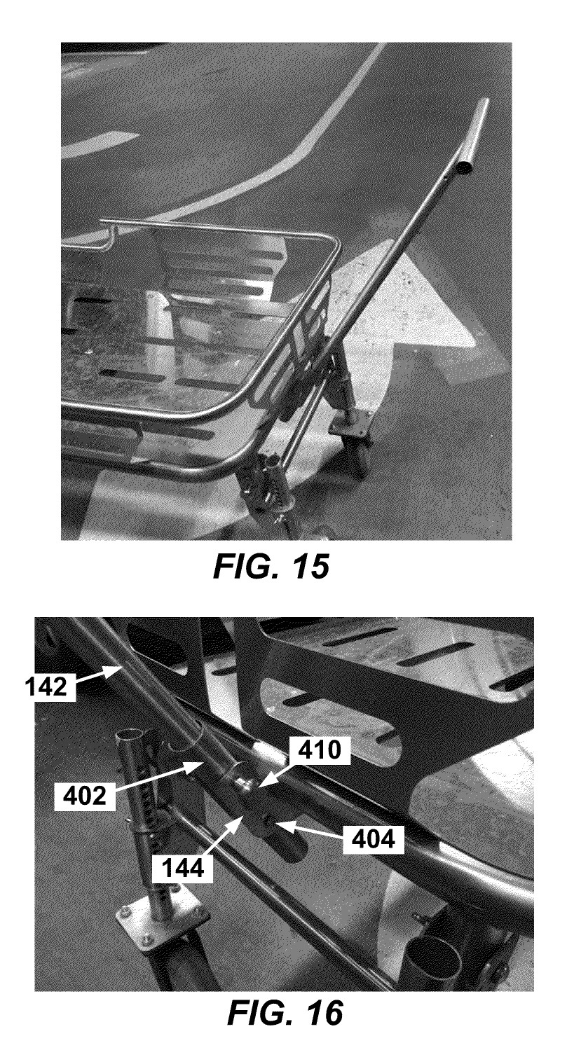

FIGS. 15 and 16 depict views of active position of a handle assembly 140 of a cargo carrier 100 in accordance with an embodiment of the present invention. As shown in FIG. 15, the handle sleeve 402 and T-handle 142 have been rotated into the active position about the pivot point 404 of the pivot bracket 144 of the handle assembly 140. FIG. 16 shows the handle sleeve 402 and T-handle 142 locked in the active position by a pin 410 secured through active position locking hole 406 in the pivot bracket 144.

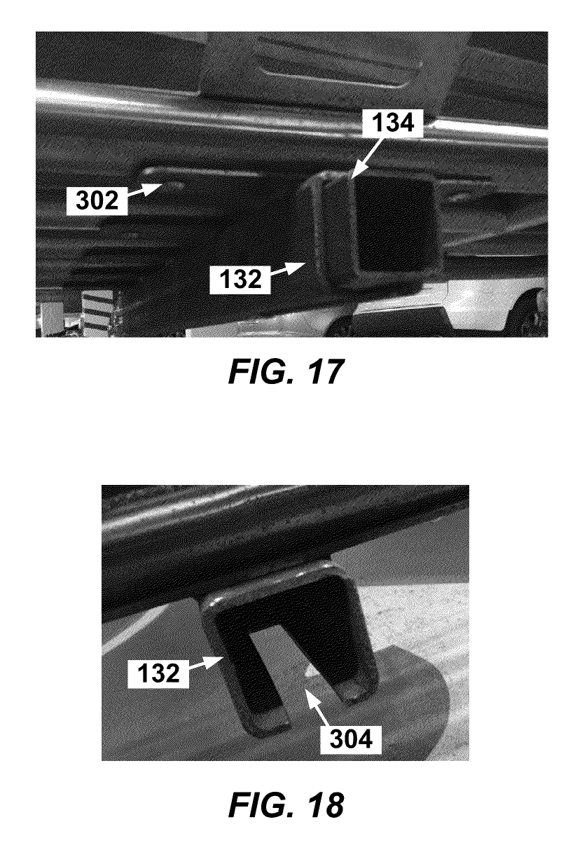

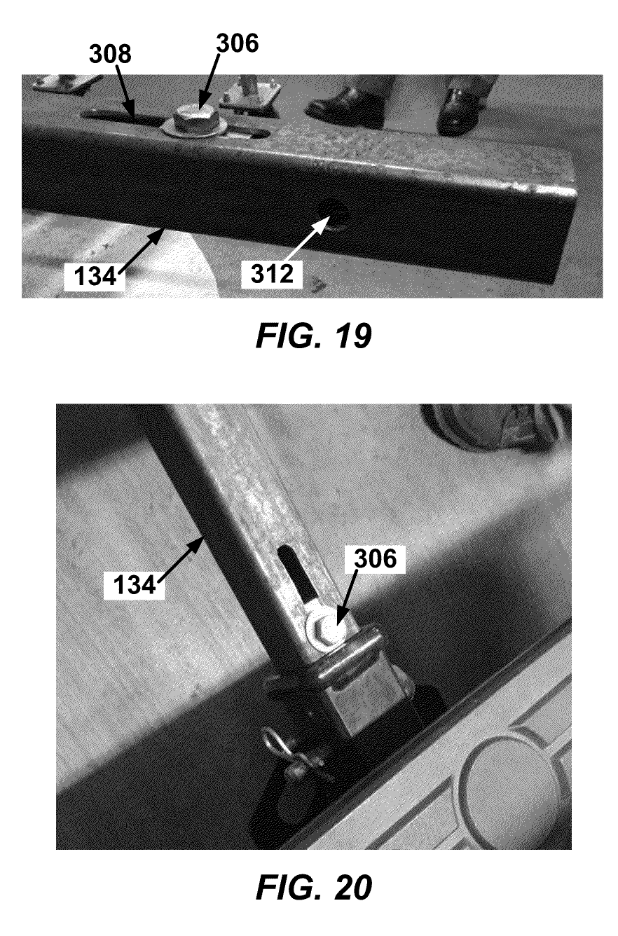

FIG. 17 depicts a view of a hitch assembly 130 of a cargo carrier 100 mounted to the underside of the storage assembly 110 via mounting tabs 302, in accordance with an embodiment of the present invention. As shown in FIG. 17, the adjustable hitch tongue 134 is in a retracted position within the hitch housing 132. FIG. 18 depicts an end view of hitch housing 132 in accordance with some embodiments of the present invention. FIG. 18 shows the hitch housing 132 without the adjustable hitch tongue 134 inserted. FIG. 18 also shows the hitch stop slot 304 for receiving the hitch stop assembly 306 when the adjustable hitch tongue 134 is in the retracted position. FIG. 19 depicts a side perspective view of an adjustable hitch tongue 134 of a cargo carrier 100 in an extended position, in accordance with an embodiment of the present invention. FIG. 20 depicts a top perspective view of an adjustable hitch tongue 134 of a cargo carrier 100 in an extended position inserted into a vehicle hitch with the hitch stop assembly 306 flush to the vehicle hitch or receiver, in accordance with an embodiment of the present invention.

It will be appreciated by those skilled in the art that the invention can be embodied in other specific forms without departing from the spirit or essential characteristics thereof. For example, while the invention has been described in the context of a hitch mounted cargo carrier for luggage and other belongings, the concepts described herein need not be limited to these illustrative embodiments. For example, the concepts described herein can be equally applicable to other types of movable carriers or carriers that are affixed to other objects.

Additionally, the specific configurations, choice of materials, and the size and shape of various elements could be varied according to particular design specifications or constraints according to the materials used and the manufacturing conditions. Such changes are intended to be embraced within the scope of the invention.

The presently disclosed embodiments are, therefore, considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A cargo carrier comprising:
a storage assembly;
a first leg assembly comprising a first wheel and a second wheel, the first leg assembly attached to an underside of the storage assembly proximate a first end of the storage assembly;
a second leg assembly comprising a first wheel and a second wheel, the second leg assembly attached to the underside of the storage assembly proximate a second end of the storage assembly;
a hitch assembly attached to the underside of the storage assembly along a center line of the storage assembly; and
a handle assembly attached proximate a first end of the storage assembly.

2. The cargo carrier according to claim 1, the storage assembly comprising a top frame, a bottom frame, and a carrier base;
wherein the top frame is affixed to a top edge of the carrier base and the bottom frame is affixed to a base of the carrier base;
the storage assembly defining an area where cargo may be stowed.

3. The cargo carrier according to claim 1, the first leg assembly and the second leg assembly each comprising a pair of adjustable legs affixed to a pivot assembly, each adjustable leg having a caster affixed to a lower end;
the first leg assembly and the second leg assembly each being pivotable from a retracted position to a deployed position,
wherein the first leg assembly and the second leg assembly are configured to be pivoted to the retracted position when the cargo carrier is affixed to a vehicle hitch, and
wherein the first leg assembly and the second leg assembly are configured to be pivoted to the deployed position for independently moving the cargo carrier from a first location to a second location.

4. The cargo carrier according to claim 3 wherein two or more of the casters affixed to the adjustable legs can be adjusted from a fixed straight-line operation to a 360-degree rotation operation.

5. The cargo carrier according to claim 3 wherein each adjustable leg can be adjusted between a height of 11 inches and 22 inches independently.

6. The cargo carrier according to claim 1, the hitch assembly comprising:
a hitch housing affixed to the underside of the storage assembly;
an adjustable hitch tongue which can be received within the hitch housing; and
a hitch pin for securing the adjustable hitch tongue within the hitch housing;
wherein the adjustable hitch tongue can be transitioned from a retracted position to an extended position within the hitch housing to provide for mounting the cargo carrier to a vehicle hitch.

7. The cargo carrier according to claim 6, the adjustable hitch tongue further comprising a hitch mounting hole and an adjustable hitch stop which can be set to allow for alignment between the hitch mounting hole of the adjustable hitch tongue and a mounting hole on a vehicle hitch receiver.

8. The cargo carrier according to claim 7, the hitch housing further comprising a slot for receiving the adjustable hitch stop when the adjustable hitch tongue is placed in a retracted position.

9. The cargo carrier according to claim 1, the handle assembly comprising:
a pivot bracket affixed proximate the first end of the storage assembly;
a handle sleeve affixed within the pivot bracket such that the handle sleeve can pivot about a pivot point from a active position to a storage position;
a handle affixed within the handle sleeve and that can pivot along with the handle sleeve from the active position to the storage position;
a handle guide affixed to the underside of the storage assembly for receiving the handle when in the storage position; and
a pin to secure the handle sleeve and the handle in either of the active position or the storage position.

10. A method of transporting cargo comprising:
extending an adjustable hitch tongue of a cargo carrier from a retracted position;
aligning the adjustable hitch tongue with a vehicle hitch receiver;
securing the adjustable hitch tongue within the vehicle hitch receiver; and
retracting one or more leg assemblies of the cargo carrier, each leg assembly comprising a first wheel and a second wheel.

11. The method according to claim 10 further comprising adjusting a height of one or more adjustable legs of the one or more leg assemblies based on a height of the cargo carrier when secured within the vehicle hitch receiver.

12. The method according to claim 10 further comprising adjusting a hitch stop assembly of the adjustable hitch tongue based on a correct alignment between a securing hole in the adjustable hitch tongue and a securing hole in the vehicle hitch receiver.

13. The method according to claim 10 further comprising:
disengaging a handle assembly from an active configuration;
inserting a handle of the handle assembly within a handle guide for storage; and
securing the handle assembly in a storage configuration.

14. The method according to claim 10 further comprising:
extending the one or more leg assemblies of the cargo carrier;
disengaging the adjustable hitch tongue from the vehicle hitch receiver; and
transitioning the adjustable hitch tongue to a retracted position within a hitch housing of the cargo carrier.

15. The method according to claim 14 further comprising setting the first wheel and second wheel of one of the leg assemblies from a 360-degree rotation operation to a fixed direction operation.

16. The method according to claim 14 further comprising:
disengaging a locking mechanism of a handle assembly in a storage configuration;
extracting a handle of the handle assembly from a handle guide;
pivoting the handle to an active position of the handle assembly; and
securing the handle assembly in an active configuration using the locking mechanism.

17. A cargo carrier comprising:
a storage assembly;
a first retractable leg assembly comprising a first wheel and a second wheel, the first leg assembly attached to an underside of the storage assembly proximate a first end of the storage assembly;
a second retractable leg assembly comprising a first wheel and a second wheel, the second leg assembly attached to the underside of the storage assembly proximate a second end of the storage assembly; and
a hitch assembly attached to the underside of the storage assembly along a center line of the storage assembly, the hitch assembly comprising:
a hitch housing affixed to the underside of the storage assembly;
an adjustable hitch tongue which can be received within the hitch housing; and
a hitch lock for securing the adjustable hitch tongue within the hitch housing;
wherein the adjustable hitch tongue can be transitioned from a retracted position to an extended position within the hitch housing to allow for affixing the cargo carrier to a vehicle hitch.

18. The cargo carrier according to claim 17, the adjustable hitch tongue further comprising a hitch mounting hole and an adjustable hitch stop which can be set to allow for alignment between the hitch mounting hole of the adjustable hitch tongue and a mounting hole on a vehicle hitch receiver.

19. The cargo carrier according to claim 18 further comprising:
the first retractable leg assembly and the second retractable leg assembly configured to be transitioned to a retracted position when the cargo carrier is affixed to the vehicle hitch, and
the first retractable leg assembly and the second retractable leg assembly configured to be transitioned to a deployed position for independently moving the cargo carrier.

20. The cargo carrier according to claim 18, the first retractable leg assembly and the second retractable leg assembly each further comprising:
a first adjustable leg; and
a second adjustable leg;
the first adjustable leg comprising the first wheel affixed to a lower end of the first adjustable leg;
the second adjustable leg comprising the second wheel affixed to a lower end of the second adjustable leg; and
the first adjustable leg and the second adjustable leg each configured to be independently adjusted in height.
